(19) United States
(12) Patent Application Publication
(10) Pub. No.: US 2023/0261971 A1
(43) Pub. Date: Aug. 17, 2023

(54) Robust Vertical Redundancy Of Networking Devices

(71) Applicant: Tamer Ahmed, Redmond, WA (US)

(72) Inventor: Tamer Ahmed, Redmond, WA (US)

(21) Appl. No.: 17/803,172

(22) Filed: Feb. 15, 2022

(51) Int. Cl. H04L 45/00; H04L 49/15; H04L 49/00

(52) U.S. Cl. CPC H04L 45/22; H04L 49/15; H04L 49/70

(57) ABSTRACT

A communication network environment includes a set of at least two redundant network devices, a plurality of downstream devices (or networks,) a plurality of upstream devices (or networks,) and a set of two switching devices comprising a plurality of switching modules, the downstream devices (or networks) communicatively coupled to network interfaces of the set of redundant network devices using a plurality of switching modules, the upstream devices (or networks) communicatively coupled to network interfaces of the set of redundant network devices using a plurality of switching modules, each switching module configured to switch the communication paths between the set of redundant network devices and one of the downstream devices (or networks) or to switch the communication paths between the set of redundant network devices and one of the upstream devices (or networks) so that each of the downstream devices (or networks) or each of upstream devices (or networks) has a switchable communication paths to each network device of the set of redundant network devices. The switching device, by arbitrating the next best alternate communication path, is capable of instantaneously recovering from network communication path failures.

### BACKGROUND

Computer networks consists of various interconnected devices/nodes (e.g., routers, switches, computing nodes, and etc.) Computer networks provides physical medium to transport data among networked nodes and are backbone of various industries such as cloud computing, financial electronic trading, telecommunications networks and etc. Data centers are building blocks of large-scale computer networks where a number of computing nodes are networked together to form large scale computing horsepower for the underpinning application. Cloud computing offers their computing horse power in a form of software as a service to different service providers.

A typical topology of data centers is based on 4 level hierarchy where computing nodes are leaf nodes. Computing nodes are connected to first level of networking nodes via direct attach copper (DAC) cable. First level is widely known as Tier-0, Top of Rack (ToR) or simply T0. T0 networking devices provide access for computing nodes to the network and so are called access network. T0 devices are connected to multiple Tier-1 (or simply T1,) networking devices. T1 networking devices are known as aggregation network. Similar connections exist between T1 and Tier-2 (or simply T2,) networking device where T1 networking devices are connected to multiple T2 networking devices. T2 networking device are known as core network. It is important for computer networks to reduce or eliminate downtime due to cabling, networking device or power device failures. This resiliency presents itself in a form of multiple path connection to T0, T1, and T2 networking devices. Multiple connections between two networking nodes are possible by virtue of link aggregation control protocol (or LACP.) If one or more link fails, LACP is capable of redistributing “future” networking traffic to healthy links. However, and while failure is being detected, traffic traveling through failing links will be lost until LACP kicks and redistributes traffic to other links. It is worth mentioning that a number of computing nodes has single cable to T0 devices and are not offered any form of resiliency to cabling, T0 networking device, and/or power failures. Those failures may result in isolating computing resource(s) from the network for and extended time or may result in traffic blips where traffic is lost for brief period of time. The scale of failure impact may range from brief traffic blips to a complete isolation of entire computing nodes rack.

Depending on the underlying computer network application, a computer network failure may result in brief traffic blip and in thereafter, loss of investment in case of electronic trading due to loss of financial transaction executions, or due to delayed decisions in real-time blockchain indexers applications. Prolonged computer network failure will exacerbate the financial impact further, or result in new category of loss such as loss of quality of service presented to down stream or end user and loss of potential customers' interests. In addition, computer network may consist of software components that require maintenance and frequent patching as potential online threats arise or feature enhancements are introduced. Maintenance of T0 devices has to be scheduled and computing nodes may need to be migrated to new T0 in service. In some circumstance and based on service level agreement (SLA) the owner of the computer service has to be notified beforehand which result in inefficiencies addressing and emergent computer network threat.

It is with respect to these considerations and others, the disclosure made herein is presented.

### SUMMARY

The disclosed embodiments describe technologies for providing efficient redundant networking paths for networking devices. Those technologies provide vertical redundancy data paths and are intended to work in conjunction with existing horizontal redundancy data paths technologies such as LACP. It is worth noting that while LACP provide a form of horizontal redundancy, it is main advantage is to provide increased data capacity between networking devices. The main advantage of the new technologies is its inherent ability to eliminate or minimize network traffic blips to become unnoticeable to hard real-time distributed applications. When used in a datacenter between T0 and computing devices or servers, the new technologies eliminate the possibility of data loss due to T0 device failures and provide ability to have redundant computing devices or server.

It is often the case existing computing nodes in a data center are equipped with single network interface card (NIC) which prevent incorporation of horizontal redundancy technologies at the access level between T0 networking devices and computing nodes (servers.) Equipping those servers with a second or more NIC(s) is both costly and time-consuming task. When incorporated, horizontal redundancy technologies such as LACP, do suffer from relatively long delays when recovering from network failures such as link or device failures. For a saturated network link, recovering from link failure will results in sudden shift of traffic to other links in the link group resulting in data packets drops and traffic blips. Recovering from a device failure will result in extended traffic disruption period until adjacent routing tables are updated to take out routs leading to the failing networking device.

Semi vertical redundancy technology is adopted between server and T0 device in a previous filing, however, it is inefficient in preventing data traffic blips due to its inherent reliance of software tunnels to forward traffic between networking devices at the access layer level and on access control list (ACL) rules aiming at preventing duplicate traffic presented to the aggregation layer. Those aforementioned inefficiencies result in prolonged traffic blips that are not tolerated by real-time network applications and would result in lost opportunities.

The disclosed embodiments describe an M:N way redundancy techniques that enable the computer network (e.g., data center) to respond instantly to network failures such as failed network link, failed network device and/or decommissioned network device. In an embodiment, an M:N way redundant instrument may comment two networking device where one end consists of M pseudo-identical networking devices (or nodes) and the other end consists of N pseudo-identical networking devices (or nodes.) M and N represent the number of provided vertical redundancy of each networking nodes respectively. It is imported that vertically redundant nodes to have the same identical traffic steering behavior in case of vertical redundancy coexists with vertical redundancy techniques or incase of multiple paths exist for egressing traffic. Data traffic steering in vertically redundant nodes should follow the same steering function (or hash function) and same flow packet should egress from the same port on each vertically redundant device. This requirement is relatively easy to fulfill and most off-the-shelf networking devices support programing (or configuring) of traffic hashing/steering function and its associated parameters. The M:N redundancy module is a switch or multiplexer where each of network facing sides has and M and N ports respectively where M and N each represents a set of redundant set of networking device each containing M and N networking devices. The multiplexer could be embedded into the networking cable or in other embodiment, it could be a standalone device connected to regular DAC (or QSFP or similar contemporary cabling technology) cable. The new multiplexing device selects one of port of the redundant set to be primary (or active) port (or device) where remaining ports are designated as secondary (or passive) ports (or devices.) The primary/active port of set M will broadcast all ingress traffic to all egress traffic ports of set N and vice versa, the primary/active port of set N will broadcast all ingress traffic to all egress traffic ports of set M. All ingress traffic to secondary/passive ports for both sets M and N is null terminated, blackholed, or dropped. It is important to note that ingress traffic blackholing of secondary/passive provides the ability to filter redundant traffic at the hardware level and eliminate the need of slow control plane programmed ACL rules adopted in an earlier application. Similarly, the broadcast of ingress traffic of the primary/active port provide the ability to forward traffic at the hardware level to every networking node of the redundant set. The latter criterion eliminates the need of slow control plane programmed forwarding rules adopted in an earlier filing. In an embodiment, the primary/active may be selected by control plane based on link health monitoring protocol such bidirectional forwarding detection (BFD,) or similar protocols. Alternatively, the primary/active selection could be selected by the switching/multiplexing device based on detection of carrier loss or loss of clock and data recovery (CDR) signals and/or similar layer-1 synchronization signals. The latter choice provides fast, efficient and instantaneous switching ability when a a networking device malfunctions or experiences sudden loss of power. Similarly, the switching/multiplexing device will be powered by each networking devices of both sets in order to achieve maximum protection against power loss.

On each of the vertically redundant set, each redundant networking node may receive the same data at almost the same time, each redundant node may forward the same packets via the same port to the next hop of the computer network (e.g., data center.) at similar time, regardless of the state of the ingress port be it primary/active or secondary/standby port. The vertically redundant device does not change routing behavior based on individual port state when connected to switch/multiplexing device. Furthermore, the redundant device in a given redundancy set, need not to communicate port state to peers within the same set. If the vertically redundant devices are computing nodes, each node can host the same application with different implementations in order to maximum fault tolerant in case of one implementation carries a software bug. If one application crashes, an application manager can switch the port to secondary/standby in order to provide service while it recovers from faults. Similarly, if a primary/active computing node loses power or suddenly reboots, the next computing node of the redundant set will be selected to switch roles and become primary/active computing node by virtue of switching/multiplexing device auto select feature.

It is common to use M:N vertically redundancy where both M and N are 2. However, in an embodiment, choice of both M and N as 3 while connecting only two networking devices and/or computing devices one each end, provides the capability of “make before break” approach when servicing a redundant node. The approach may be used in planned service to eliminate the period of time when a redundant set cardinality falls to only one device by connecting a new redundant node before servicing an existing node.

In some embodiments, the properties of the physical layer (or layer-1) may be used to conceal the presence of switching/multiplexing device between two connected networking nodes and/or computing nodes of each of the vertically redundant sets. Ethernet networks are common choice and some embodiments, each set of vertically redundant devices may advertise the same network prefixes and utilize one virtual medium access control (MAC) address. While, other embodiments may assign a MAC address to the switching/multiplexing device and have the switching/multiplexing device replace the MAC address of the source port of every egressing Ethernet frame.

The techniques shown herein address deficiencies related to failures of networking devices and/or computing nodes. For example, data center may eliminate data blips and reduce the time when its computing nodes may lose network level connectivity and stop servicing downstream customers. In addition, computing nodes redundancy is possible where multiple instances of the same application are ready to provide service once the primary/active instance loses its connectivity. Also, the access network can now have planned service without the need to move customer virtual servers to different rack and/or provide an advance notice to customers providing further agility to respond to emergent incident. In addition, data lost or blips due to those unplanned failures of networking nodes are subdued and/or eliminated. Other technical benefits not mentioned herein could be realized by using techniques and technologies disclosed herein.

The summary here in provides an introduction of concepts in a simplified form. Those concepts are described in detail in a subsequent section named “Detailed Description.” This summary is not a full identification of the key feature (or essential feature) of the claimed subject matter. This summary is not to be used to limit the scope, by any means, of the claimed subject matter. Furthermore, the claimed subject matter is not intended to solve every or all disadvantages mentioned in any part of this disclosure.

### DRAWINGS

The Detailed Description section makes reference to various accompanying drawings. The drawings show via means of illustrations various components, embodiments and examples with different level of details. Similar components have alike numbers throughout various figures. It is not intended to draw relative measures of mechanical dimensions of various components given in the drawings.

FIG. 1 is a diagram of a typical data center topology for access to computing nodes and resource in accordance with the present disclosure;

FIG. 2A is an illustration of an M:N vertically redundant network in accordance with the present disclosure;

FIG. 2B is an illustration of an M:N vertically redundant network in accordance with the present disclosure;

FIG. 2C is an illustration of an M:N vertically redundant network devices in accordance with the present disclosure;

FIG. 2D is an illustration of an 1:M:N:1 vertically redundant network devices in accordance with the present disclosure;

FIG. 2E is an illustration of and 1:M:1 vertically redundant network devices in accordance with the present disclosure;

FIG. 3A is an illustration of a 2:2 vertically redundant network devices in accordance with the present disclosure;

FIG. 3B is an illustration of 1:2 and 2:1 vertically redundant network devices in accordance with the present disclosure;

FIG. 3C is an illustration of 1:2, 2:3, and 3:1 vertically redundant network devices in accordance with the present disclosure;

FIG. 3D is an illustration of 2:2, 2:3, and 3:1 vertically redundant network devices in accordance with the present disclosure;

FIG. 4 is a flowchart depicting an example procedure in accordance with the present disclosure;

FIG. 5 is a flowchart depicting an example procedure in accordance with the present disclosure;

FIG. 6 is a flowchart depicting an example procedure in accordance with the present disclosure; and

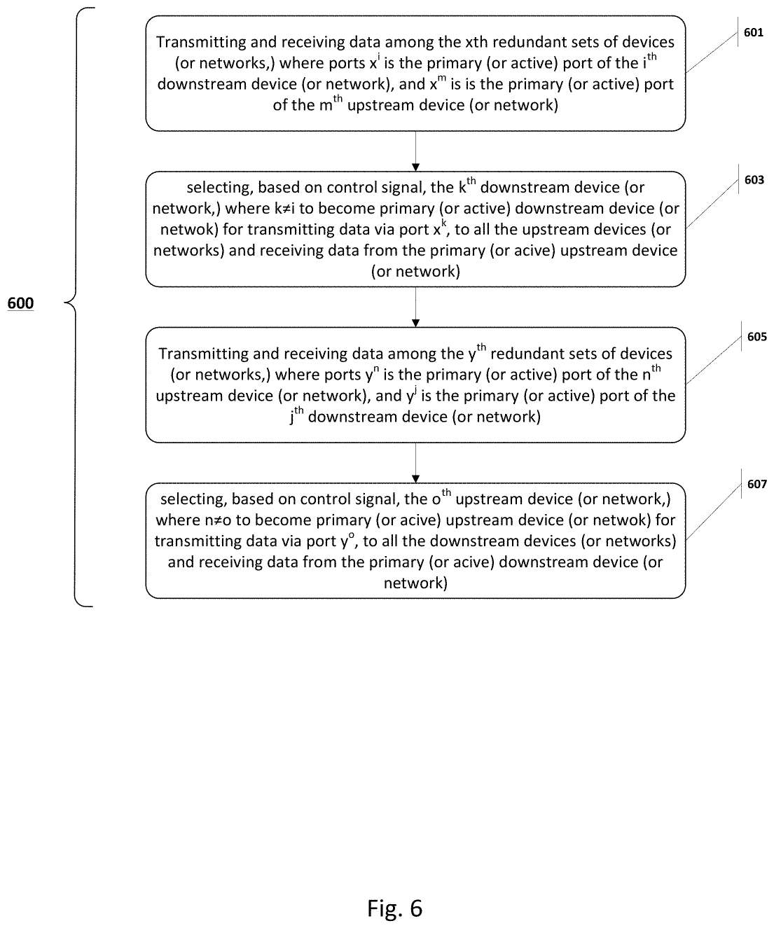

FIG. 7 is an example computing node in accordance with the present disclosure.

### DETAILED DESCRIPTION

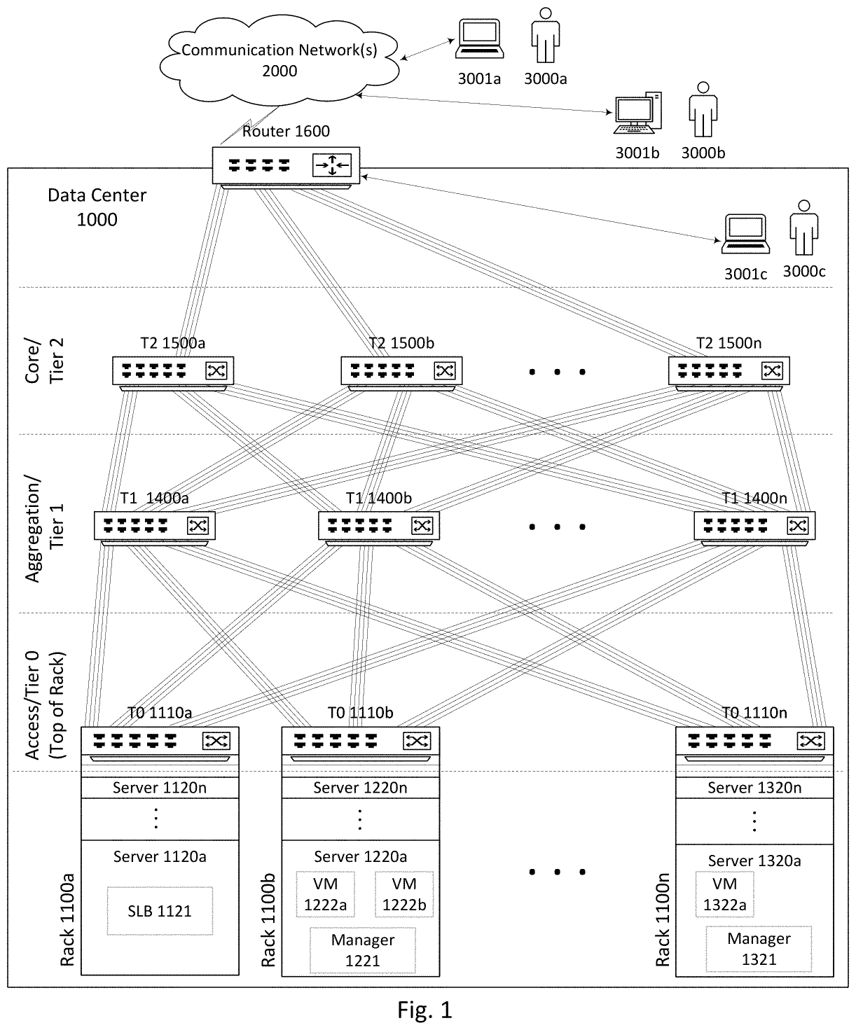

The disclosed embodiments contain description of vertically redundant network devices that provide alternate paths to instantly recover from network and/or link failures and prevent a network device or computing node from being isolated from the control and/or data networks. In an embodiment, a switch or multiplexer is a device that may be embedded within a DAC (or similar technology) cable which will be referred to herein as v-redundant cable. The addition “v-” is to assert the redundancy dimension which is orthogonal to other horizontal redundancy technology such as LACP. In some embodiments, the v-redundant cable may provide switching capability at physical layer (OSI layer-1.) In some embodiment, the v-redundant cable might provide switching capability at layer 1.5 which indicates the ability of the v-redundant cable to alter layer-2 source MAC address with no further processing of the layer-2 contents. The source MAC address may be programmed into the v-redundant cable or permanently configured during manufacturing process. In some implementation, the v-redundant cable may inspect the destination MAC address and broadcast traffic to the same redundant set if the MAC address happens to be one of the broadcast local addresses. The v-redundant cable can be used between any network device and/or computing nodes. In some embodiments, the v-redundant cable may be used between computing nodes and access network and between access network and aggregation network in a typical data center such as data center depicted in FIG. 1. The v-redundant cable is not limited to specific layer-1 technology and may be used with other layer-1 technologies.

In an embodiment, the v-redundant cable may interconnect a number of ports of M upstream network devices to a corresponding number of ports of N downstream networking device or computing nodes. The term upstream and downstream network device may be used interchangeably with uplink and downlink, or lefthand side and righthand side with no loss of generality. The two redundant sets are peers to one another and the word peer will be used in conjunction with either downstream/upstream device in order to reference upstream/downstream devices of the v-redundant cable. Also, a network device might server as upstream to a set of network devices and at the same as downstream device to a disjoint set of network devices. The v-redundant cable will broadcast ingress data traffic of the primary downstream network device (or computing node) to every egress port of upstream network devices. Vice versa, the v-redundant cable will broadcast ingress data traffic of the primary upstream network device to every egress port of downstream network devices (or computing nodes.) The v-redundant cable may be configured to switch between upstream network devices (or downstream network device) when link carrier is lost (or loss of CDR,) or when LACP (or a similar Layer-2 protocol) indicates loss of a link, or when BFD (or a similar layer-3 protocol) indicates loss of a link. The choice of one of the secondary network devices to become primary may based on deterministic priority order (or random order.) In an embodiment, the computing nodes (or servers) in a data center may be downstream device to T0 device and T0 device are downstream to T1 devices and are all connected using v-redundant cables.

The v-redundant cable provides a methodology to indicate to a vertically redundant device if it is connected to an upstream side or downstream side of the v-redundant cable. The v-redundant cable also provides a methodology to indicate to a connected device if the associated port is currently set to primary/active or set to secondary/standby state. In some embodiments, the v-redundant cable provides notification to the connected device for which its associated port has just changed role from primary/active to secondary/standby and/or vice versa.

The v-redundant cable may be configured to make decision when a network failure is detected and may select the next port with valid and healthy layer-1 state to become active/primary port of the upstream/downstream redundant set of network devices or computing nodes. In some implementations, the v-redundant cable may contain a microcontroller unit (MCU) to control various aspects of the network ports and/or communicate with the connected network devices or computing nodes. The MCU unit may be able to run a modifiable code. In an embodiment, the MCU may be able to communicate with each connected network device using inter-integrated circuit (I2C) bus (or similar technology bus.) In some implementations, the MCU may be able to assert an interrupt line in order to indicate an event to one or more connected network devices. MCU notification event list may contain but not limited to, port state change event from primary to secondary and vice versa, link state change event from on to off and vice versa, and various link or MCU health metrics and measurements. In some implementation, the MCU may indicate loss of link to every redundant network device if none of the upstream network device links is trained and vice versa, the MCU may indicate loss of link to every redundant network device if none of the downstream network device links is trained. LACP protocol or similar horizontal redundancy protocol may make use of new v-redundant link state change event to cease hashing traffic through that port (or port set if vertical redundant set of network devices is envisioned.) The MCU or the v-redundant cable will limit selection of primary port to one the full trained and in “up” state ports of a redundant set, or to a random port if every port associated with a redundant set, is not trained or in “down” state.

In some implementations, a network device connected to a v-redundant cable may select the state of its associated port, namely the network device may arbitrarily switch its associated port to primary/active or secondary/standby. The MCU may ensure that only one port is primary/active in a redundant set at any time. If a network device switches its associated port to standby, the MCU may select one a random port with valid link state to serve as next primary/active port or may deny such a change in case no port with valid state is ready to serve as next primary/active. In some implementations, a network device connected to a v-redundant cable may switch the state of a port associated with any other network devices in the same redundant set or the other (or peer) redundant set.

In many embodiments disclosed herein, the control and plane modules of a network device or a computing device, may run unaware of the current status of each port connected to a v-redundant cable. It is often a problem with M:N redundant applications is a problem of state synchronization and negotiations. In some embodiments, control plane applications running on a network device and that are connectionless application, may continue to run with unchanged. In some embodiments, control plane applications running on a network device and that are connection-based application, may make use of the v-redundant cable state and eavesdrops on ongoing communication between the primary applications in order to maintain state similar to the primary application and be ready to service request had the cable state been changed to active. The disclosed technique ensures that there is no duplicate egress traffic out of a redundant set in either direction, namely to its downstream devices and to its upstream devices. One of the issues with such redundancy is that the network device control plane needs to be aware of the port status and tunnel traffic to other devices in the redundant set or block duplicate traffic. The latter behavior inherently introduces delay to real time network application that may not be tolerable. Also, another issue when more than two devices are redundant, is the need for control plane to be aware of the current active device in order to properly tunnel traffic to the current active device, which may introduce undesirable signaling overhead or even result in out of sync states.

In embodiment disclosed herein, the following assumption are made:
a. All ingress traffic of a primary/active port of a redundant network device set is broadcast to every egress port of the peer redundant network device set.
b. All ingress traffic of a secondary/standby port of a redundant network device set will be blackholed, sent to null device or simply dropped.
c. Each of the network device in a vertically redundant set will be configured with same route prefixes such that packets of a given network flow will be routed to the same interface index on every vertically redundant network device of the same set.
d. Further and in the presence of LACP (or similar link aggregation protocol,) LACP should hash packet of the same flow to the very same port of the LACP group on every vertically redundant network device.
e. Ports that are member of LACP set (or similar link aggregation protocol) will continue to receive packet regardless of the port link state, as long as the v-redundant cable indicates that there is one active port in the vertically redundant set.

In the disclosure herein, network devices of a vertical redundant set may have the same virtual MAC address. Alternatively, the redundant set of network device may configure or program the v-redundant cable with virtual MAC address and the v-redundant cable may alter source MAC address of broadcast packets.

In the enclosed embodiments, a vertically redundant set of network device may have multiple ports that are connected to different v-redundant cables and the primary/active state is on a per port basis, so a specific network device of the redundant set may have a subset of the set of ports connected to v-redundant cables, with port state as primary/active while remaining subset of ports will have secondary/standby state.

FIG. 1 depicts a typical computer network environment with spine-leaf topology in which the embodiment described herein may be implemented. It should be appreciated that other multi-tier computer network topology may implement the embodiments described herein. FIG. 1 illustrates a data center 1000 that contains core layer or tier-2 (T2) network devices (or switches) “T2 1500a,” “T2 1500b,” and “T2 1500n” (which may be referred to herein singularly as “T2” or in the plural as “T2s”.) T2s are connected to a set of downstream devices shown in FIG. 1 as “T1 1400a,” “T1 1400b,” and “T1 1400n” (which may be referred to herein singularly as “T1” or in the plural as “T1s”.) Set of T1s may be called an aggregation layer in a typical spine-leaf topology. T2s may be referenced as upstream devices to T1s. Similarly, T1s are connection to a set of downstream devices shown in FIG. 1. As “T0 1110a,” “T0 1110b,” and “T0 1110n” (which may be referred to herein singularly as “T0” or in the plural as “T0s”.) T0s may be referred to as access layer or top of rack devices (TORs). Similarly, T1s may be referred to as upstream device to T0s. Data center 1000 may provide several types of resources, such as computing resource, data communication resources, data storage resources, software as service resources and etc. Each type of resource may be available in various configurations, i.e., computing resources may be offered as virtual machines or as bare metal computing resources. Computing resources may be configured to run web application servers, real time gaming servers, financial based servers such as electronic order execution servers, media server, telecommunication functions, database servers and etc. Data storage resources may be offered as files storage devices, block storage devices and etc. Data communication resources may be offered as network interface card (NIC,) firewall or access control lists (ACLs,) gateways, network address translation (NAT) service, private/public Internet protocol (IP) addresses and etc. Some embodiment may refer to each resource as an instance, i.e., virtual machine instance or storage instance. The virtual machine instance may be offered in different specifications such as number of processors, type of processor, memory size, and operating system (OS) type and version.

FIG. 1 also shows data center 1000 configured to provide services to users “3000a,” “3000b,’ and “3000c” (which may be referred to herein singularly as “user 3000” or in the plural as “users 3000”.) Users 3000 utilize computers “3001a,” “3001b,” and “3001c” (which may be referred to herein singularly as “computer 3001” or in the plural as “computers 3001”) to access data center 1000 service via “Communication network 2000.”

FIG. 1 also shows each “T0” atop of rack of servers “Server 1120a,” and “Server 1120n” (which may be referred to herein singularly as “server” or in the plural as “servers”) that provide computing resources such virtual machines “VM 1222a” and “VM 1222b” and “VM 1322a” (which may be referred to herein singularly as “virtual machine 1x22” or in the plural as “virtual machines 1x22”, where “x” is abbreviation for 2 and/or 3.) Virtual machine 1x22 may execute web servers, media servers, electronic trading servers, database servers and etc. Other resource (not shown) such as data communication resources and/or data storage resources may be offered. Server 1120a may run software load balancer (SLB) to distribute incoming data communication to difference computer resources such virtual machine 1x22 in order to achieve higher processing efficiency. Servers may also run manager module to manager difference virtual machine instance, monitor virtual machine health, and/or provide accountancy data used for client billing.

In FIG. 1, data center 1000 may be operated by a cloud computing service provider off customer premises. Data center or part of, may coexist alongside customer on premise computing resources. Communication network 2000 provides access to computing, storage, and/or data communication resource of data center 1000. Communication network 2000 may be a publicly accessible network and/or operating by various autonomous system (AS) entities such as Internet. In some embodiments, Communication network 2000 is only accessible using virtual private networks technology and offers its resources to access-privileged users. In other embodiments, Communication network 2000 may be partially public and partial private.

Users 3000 may connect to Communication network 2000 using computers 3001. Computers 3001 may be a workstation, a server, a laptop, a smartphone, a tablet, a smart TV, or any other form of computing devices capable of performing data communication over Communication network 2000. User 3000c is shown in FIG. 1 as an internal user to data center 1000 via internal network. While only users 3000a, 3000b, and 3000c are depicted, it should be appreciated that data center 1000 may have multiple users.

Users 3000 may utilize computers 3001 to configure computing resource provided by data center 1000. Cloud provider may offer web interface to configure various aspects of data center 1000 resources, or provide a command line interface to configure computing, data storage, and/or data communication resources.

It should be appreciated that although the embodiments disclosed herein are discussed in the context of data centers, other types of computer network implementation can be utilized with the concept and technologies disclosed herein. For example, the embodiments disclosed herein might be utilized in computer networks that are not data centers nor utilize virtual machines.

It should be appreciated that FIG. 1 depicts a simplified illustration of a data center and might be missing some conventional details and many more networks and network devices may be utilized to interconnect various computer systems disclosed herein. Those network device and components should be apparent to those skilled in the art. Other embodiment may have additional computing data storage and/or data communication resources connected in a topology different from data center 1000 topology. For example, Router 1600 is shown in FIG. 1 connected directly to core layer of data center 1000 while other embodiments may include a firewall to protect data center 1000 from unsolicited accesses from publicly available network users. As shown in FIG. 1, router 1600 may forward traffic from Computer network 2000 as well as from internal user 3000c, to servers 1x20 utilizing characteristics of such communication (e.g., header information such as source and destination address, protocol number, virtual network identifier, etc.) and/or characteristic of the data center topology and/or characteristic of the virtual private network topology.

Data center 1000 shown in FIG. 1 is merely for illustration purposes and other network realizations might be utilized. It should be appreciated that various components disclosed herein might be implemented in software, hardware, firmware, or combination of software, hardware and/or firmware. Those skilled in the art may realize functionality disclosed herein using different implementations. It should be appreciated that a computing device may comprise any combination of hardware, firmware, and/or software that can interact and perform described functionality including without limitation desktop, servers, or other computing devices, database servers, network storage devices, tablets, smartphones, and others that include appropriate from of telecommunication capabilities. It should be appreciated that the functionality disclosed herein may be combined in fewer modules or spread across multiple modules that interact and perform the said functionality. Similarly, the functionality of various component described herein may not be provided and/or additional functionality may be available.

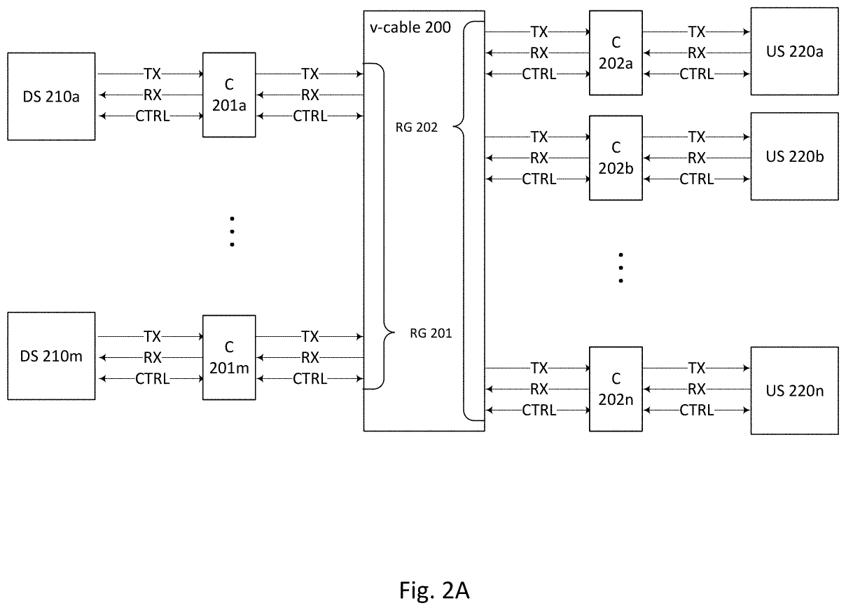

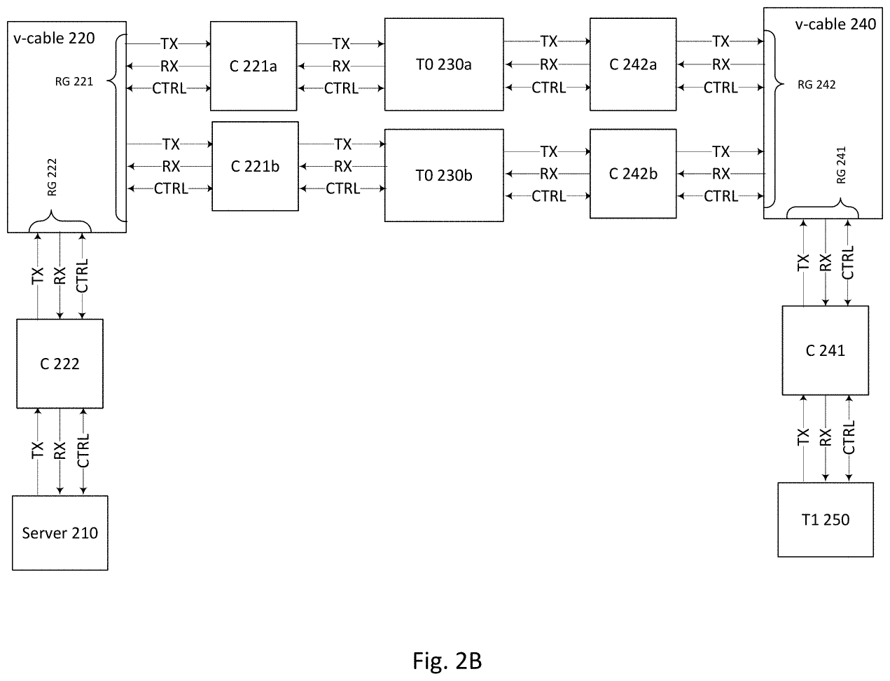

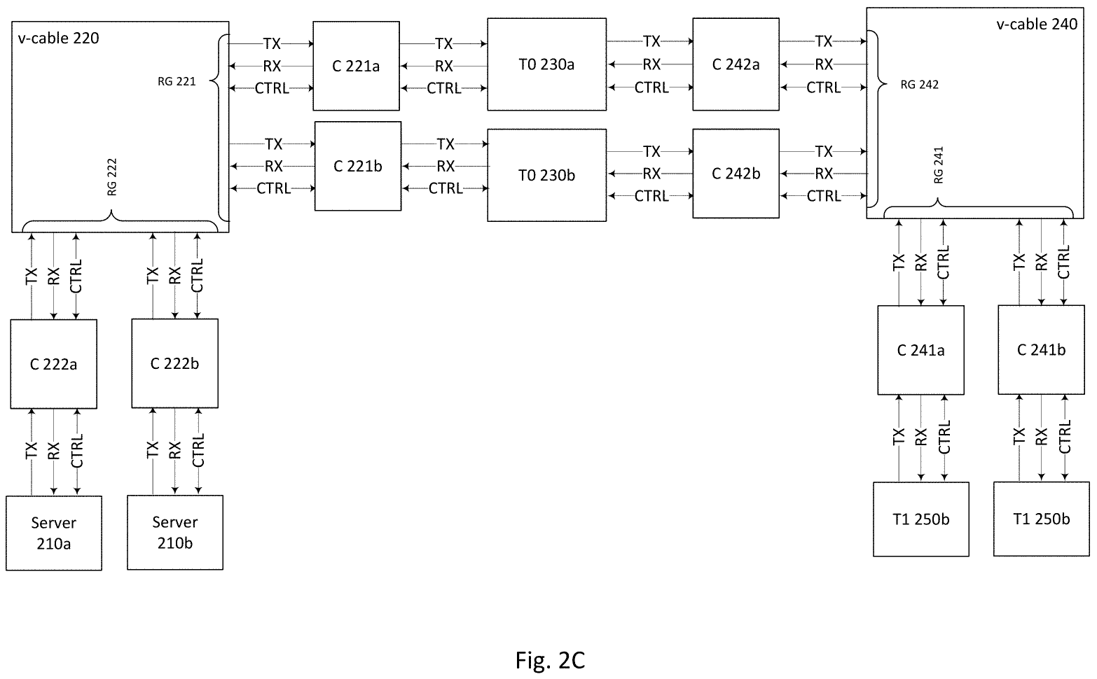

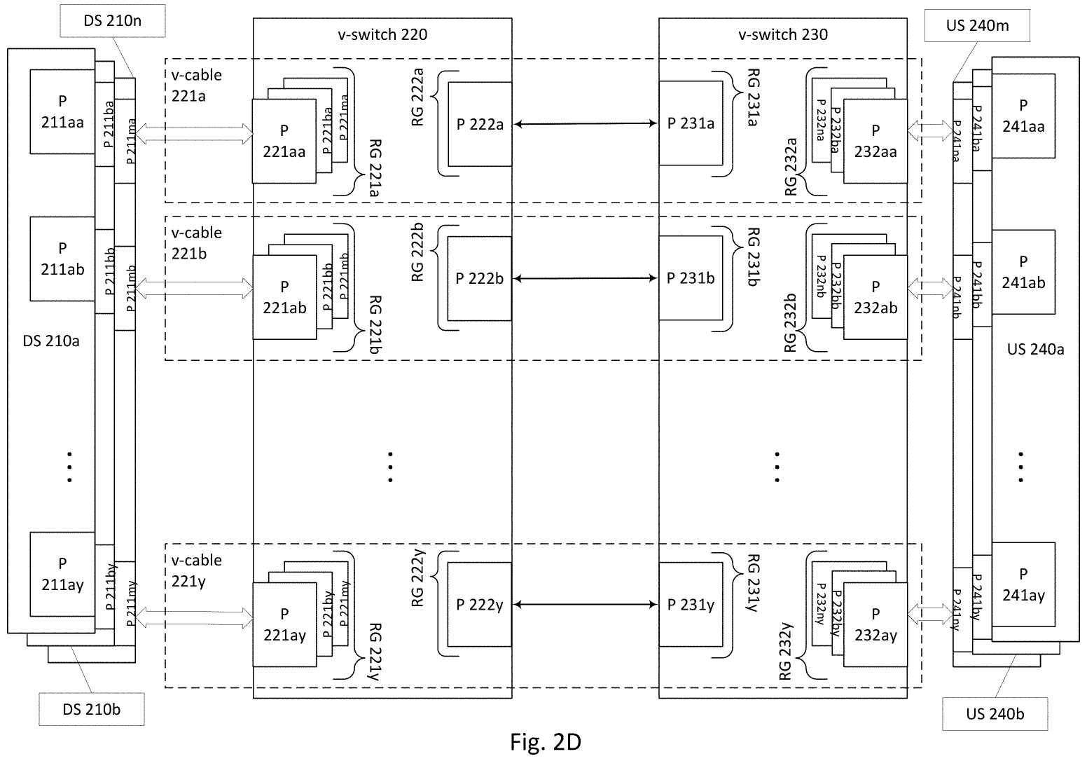

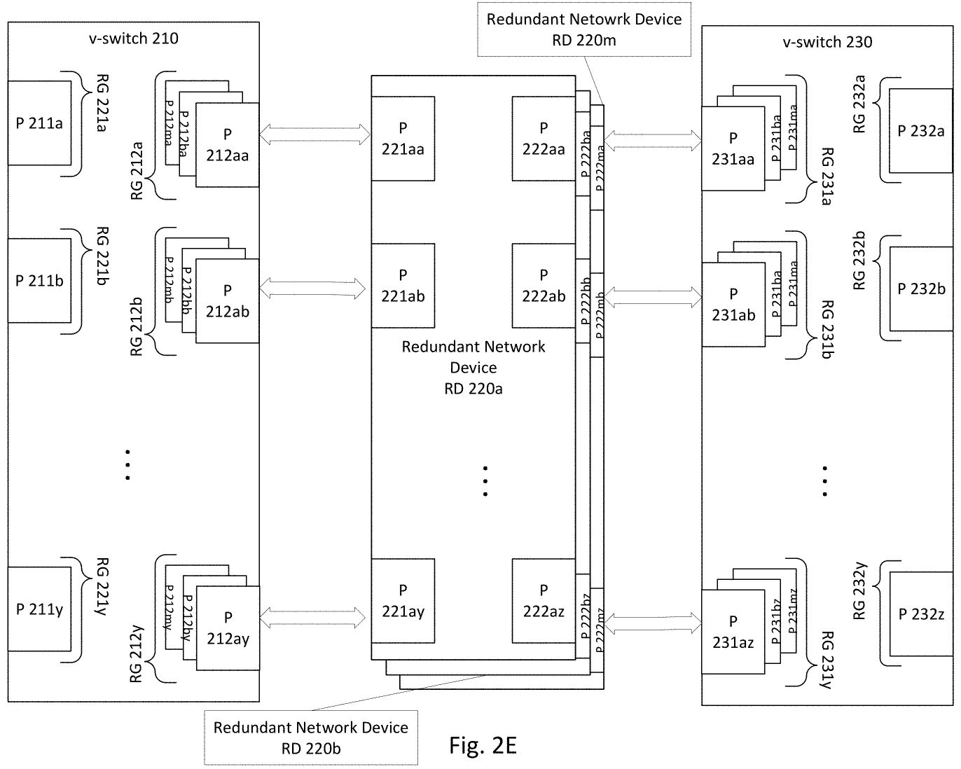

FIG. 2A depicts v-cable 200 where down network devices DS 210a, DS 210b, and DS 210m (which may be referred to herein singularly as “downstream network device 210” or in the plural as “downstream network devices 210”,) are connected may be connected to the downstream end. Downstream network device 210 may be a compute server, network switch, network router or the likes. It should be noted that a network device may serve as downstream device to a subnetwork in a network topology while serving as upstream network device to another subnetwork, at the same time. Downstream network devices 210 are connected to redundant group set RG 201 via “m” TX, “m” RX, and “m” control lines. One of the downstream network devices will be designated as primary/active while remaining ones will be designated as secondary/standby. The primary/secondary active/standby designations also extend to the network connectors C 201a, C 201b, and C201m (which may be referred to herein singularly as “connector 210” or in the plural as “connectors 210”.) FIG. 2A also shows set RG 202 of upstream devices US 220a, US 220b, and US 220n (which may be referred to herein singularly as “upstream network device 220” or in the plural as “upstream network devices 220”) via connectors 202. Similarly, a computer device out of RG 202 members will be designated as primary/active while remaining ones will be designated as secondary/standby. Both RG 201 and RG 202 are peer sets of redundant devices where the active device's (or connector's,) of one of the redundant set, ingress (incoming) network traffic will be broadcast to every network device of the peer redundant set. The ingress network traffic arriving at a secondary/standby network device (or connector) will be blackholed (blocked, or dropped.) In an embodiment, the switching element of v-cable may be embedded into the cable and may have quad small form-factor pluggable (QSFP) cable (or similar technology cables.) The v-cable shown in FIG. 2A may be called M:N v-cable where M, and N each represent the number of connectors of downstream and upstream sets respectively. In an embodiment, control lines shown in FIG. 2A may be used for I2C (or similar serial communication protocol) between network devices and the MCU embedded on the v-cable switch module. Control lines may be used to convey out-of-band status and gain access to the MCU functions, such as but not limited to, line status, active/standby status, switch line to primary/secondary and etc. In an embodiment, control status signaling may be implemented as an in-band signal. In other embodiment, out-of-band signaling may be implemented using existing wires on the cable.

In an embodiment, access to MCU is open to all network devices of both redundant sets which gives equal access to MCU function to every connected network device. In other embodiments, different level of access privileges may be configured to different network devices.

Some embodiments may include more than one MCU such as two MCUs; one of each is placed at each end close to the network devices, and have single connector between the two MCUs. The connector between MCUs module may be proprietary or based on current cable technologies such fibers or copper wires.

FIG. 2B illustrates an embodiment where a set of v-cables are used to provide redundancy at the access layer of a spine-leaf topology. The v-cable set configuration is 1:2 and 2:1 v-cables. Downstream server 210 is connected to v-cable 220 via connector C 222 and T0s 230 are connected to v-cable 220 as upstream network devices via connectors C221. Same T0s 230 are connected as downstream network devices to v-cable 240 via connectors C 242. Also, shown in FIG. 2B, T2 250 connected as upstream network device to v-cable 240 via connector C 242. Server 210 is connected to v-cable 220 as a redundant group set RG 222 while T0s 230 are connected to v-cable 220 as a redundant group set RG 221. RG 222 is a singleton and so its connector is always in primary/active state. One connector (port) may be active out of the two connectors C 221 at any time.

FIG. 2C extends FIG. 2B further and shows another embodiment that may utilize v-cable configuration of 2:2 and 2:2 redundancies. In FIG. 2C, RG 222 has two members; servers 210a and server 210b and are connected to v-cable 220 via connectors C 222. Similarly, RG 241 has two members; T1 250a and T1 250b and are connected to v-cable 240 via connectors C 241.

FIG. 2D depicts a 1:M:N:1 redundancy topology where v-switch 220 comprising a plurality of switching modules in accordance with the disclosure herein, may be connected to m downstream network devices DS 210a, DS 210b, and DS 210m (which may be referred to herein singularly as “downstream network device DS 210” or in the plural as “downstream network devices DS 210”.) Each of the downstream network devices DS 210 may comprise a plurality of ports (or network interfaces) P 211a, P 211b, and P 211y (which may be referred to herein singularly as “port 211” or in the plural as “ports 211”.) In FIG. 2D, each switching module of v-switch 220 may comprise a plurality of downstream ports (or network interfaces) P 221a, P 221b, and P 221y (which may be referred to herein singularly as “port 221” or in the plural as “ports 221”,) and a plurality of upstream ports (or network interfaces) P 222a, P 222b, and P 222y (which may be referred to herein singularly as “port 222” or in the plural as “ports 222”.) A Plurality of ports 211 may be connected to a plurality of ports 221 via DAC cable or QSFP cable.

Similarly, FIG. 2D shows v-switch 230 comprising of a plurality of switching modules in accordance with the disclosure herein, may be connected to n upstream network devices US 240a, US 240b, and US 240n (which may be referred to herein singularly as “upstream network device US 240” or in the plural as “upstream network devices US 240”.) Each of the upstream network devices US 240 may comprise a plurality of ports (or network interfaces) P 241a, P 241b, and P 241y (which may be referred to herein singularly as “port 241” or in the plural as “ports 241”.) In FIG. 2D, each switching module of v-switch 230 may comprise a plurality of downstream ports (or network interfaces) P 231a, P 231b, and P 231y (which may be referred to herein singularly as “port 231” or in the plural as “ports 231”,) and a plurality of upstream ports (or network interfaces) P 232a, P 232b, and P 232y (which may be referred to herein singularly as “port 232” or in the plural as “ports 232”.) A plurality of ports 241 may be connected to a plurality of ports 232 via DAC cable or QSFP cable. Also, a plurality of ports 222 may be connected to a plurality of ports 231.

In some embodiments, the first switching module of v-switch 220 and the first switching module of v-switch 230 may be combined into a separate unit and/or embedded into v-cable 221a. Similarly, the remaining switching modules of v-switch 220 and the corresponding switching modules of v-switch 230 may be combined into separate unit and/or embedded into v-cable 221b, and 221y (which may be referred to herein singularly as “v-cable 221” or in the plural as “v-cables 221”.)

FIG. 2D shows that technology disclosed herein may be implemented as a set of two v-switches or as a plurality of v-cables. The v-switch and v-cable may be used interchangeably throughout the technologies disclosed herein.

FIG. 2E depicts a 1:M:1 redundancy topology where v-switch 210 comprising a plurality of switching modules in accordance with the disclosure herein, may be connected to m redundant network devices RD 220a, RD 220b, and RD 220m (which may be referred to herein singularly as “redundant network device RD 220” or in the plural as “redundant network devices RD 220”.) Each of the redundant network devices RD 220 may comprise a plurality of downstream ports (or network interfaces) P 221a, P 221b, and P 221y (which may be referred to herein singularly as “port 221” or in the plural as “ports 221”,) and a plurality of upstream ports (or network interfaces) P 222a, P 222b, and P 222z (which may be referred to herein singularly as “port 222” or in the plural as “ports 222”.) In FIG. 2E, each switching module of v-switch 210 may comprise a plurality of downstream ports (or network interfaces) P 211a, P 211b, and P 211y (which may be referred to herein singularly as “port 211” or in the plural as “ports 211”,) and a plurality of upstream ports (or network interfaces) P 212a, P 212b, and P 212y (which may be referred to herein singularly as “port 212” or in the plural as “ports 212”.) A Plurality of ports 211 may be connected to a plurality of ports 221 via DAC cable or QSFP cable. Similarly, each switching module of v-switch 230 may comprise a plurality of downstream ports (or network interfaces) P 231a, P 231b, and P 231z (which may be referred to herein singularly as “port 231” or in the plural as “ports 231”,) and a plurality of upstream ports (or network interfaces) P 232a, P 232b, and P 232z (which may be referred to herein singularly as “port 232” or in the plural as “ports 232”.) A plurality of ports 212 may be connected to a plurality of ports 221 via DAC cable or QSFP cable and a plurality of ports 222 may be connected to a plurality of ports 231 via DAC cable or QSFP cable.

In an embodiment, a topology of M:N redundant devices in accordance with the technologies disclosed herein may be implemented using a plurality of M:N v-cables as illustrated in FIG. 2D, or it may be implemented using a set of two v-switch devices with a plurality of M:1 and 1:N redundancy ports. It should be appreciated that v-cables of M:N and set of two v-switches of M:1 and 1:N may be used interchangeably throughout and without limiting the technologies disclosed herein.

In an embodiment, a v-switch with M:1 redundant port specification may fall back to a specific default port out the redundancy set of M ports when v-switch power unit is malfunctioning or when power is cutoff.

Some embodiments implementing v-switch technologies disclosed herein, may configure v-switch switching modules with its own locally unique MAC address. The switching modules may update source/destination MAC addresses of ingress/egress network data packets with the configured and locally unique MAC address.

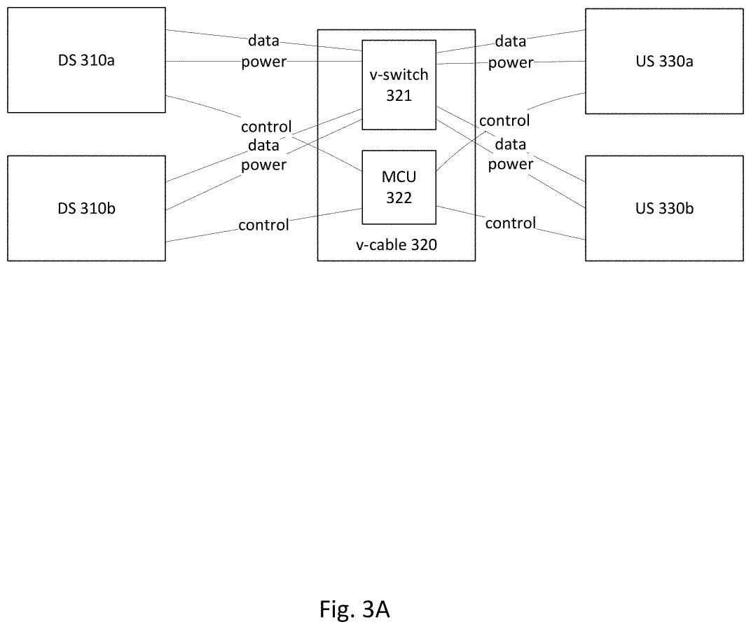

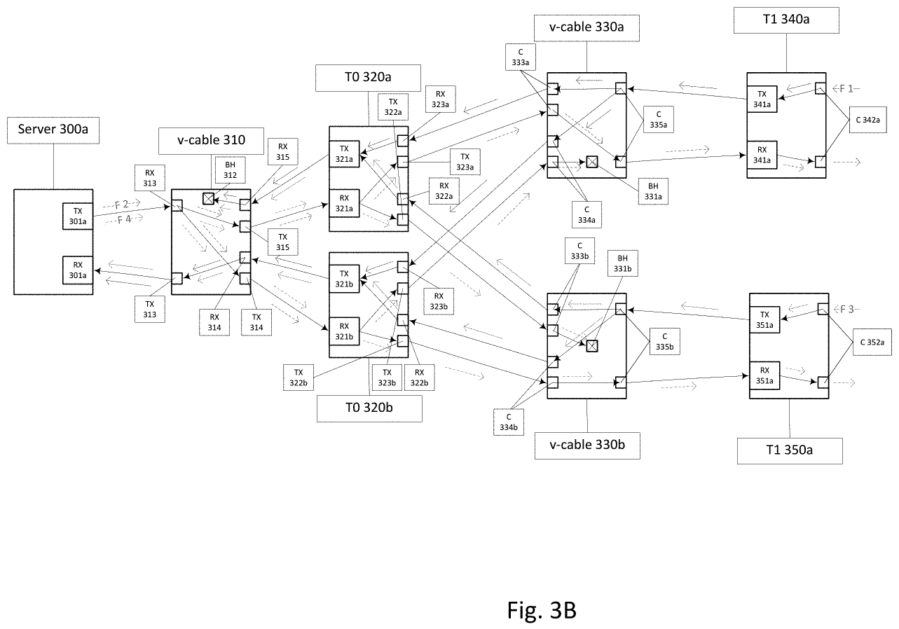

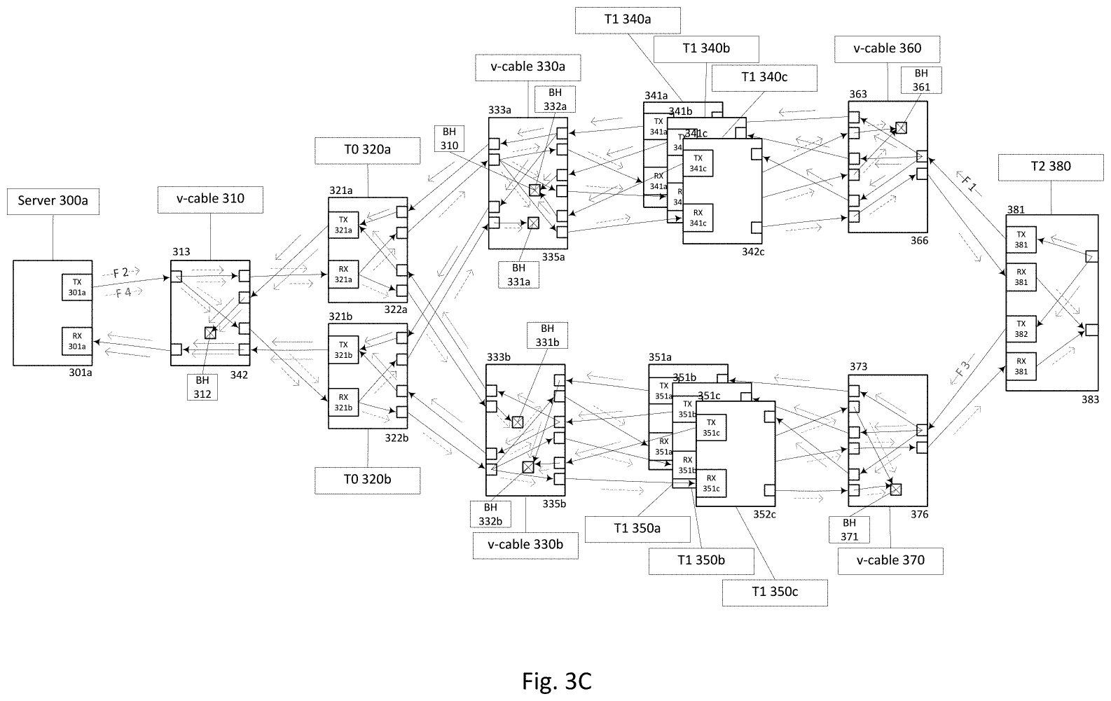

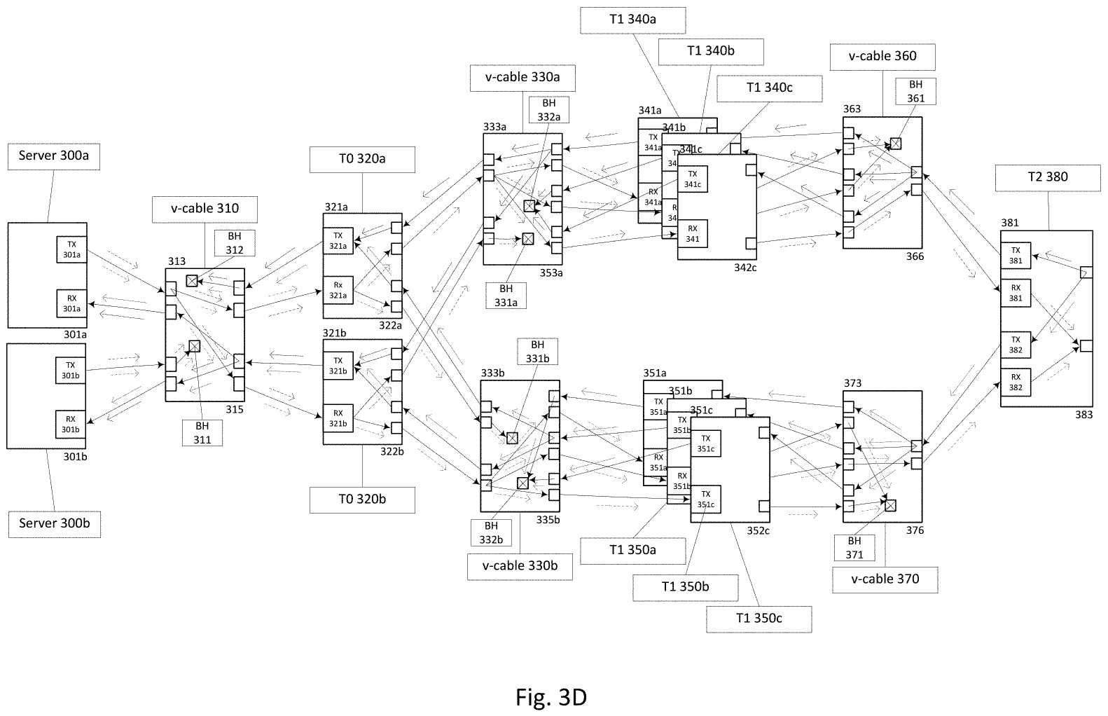

FIG. 3A shows an embodiment of an example 2:2 v-cable disclose herein. The 2:2 v-cable may have a switch module v-switch 321 and an MCU module 322. The v-switch 321 may switch date of a primary/active network device of one redundant set to the peer redundant set while blocking traffic from secondary/standby network devices. Other embodiments may have one or more v-switch modules and one or more MCU modules. While FIG. 3A show power line as separate lines, one or more data lines may also be used to power the v-switch modules for an added power redundancy.

In an embodiment, a plurality of MCU modules and v-switch modules, instead of being embedded into set of v-cables, may be grouped into two or more power-independent separate network devices of well-known form factors such as 4 (or more) rack units (4 RU or 4U) form factor while using standard cables to connect to other network devices. It should be noted that other form factor use may be adopted in other embodiments without departing from the scope of the disclosure herein. The use of v-cable and v-switch network device might be used interchangeably without loss of scope or generality.

In various embodiments, the LACP implementation may be enhanced to work efficiently with v-cables. The v-switch modules may send a control signal indicating that all ports of a redundant set have gone offline or lost CDR signal or the like. LACP may then decommission the said port(s) and hash flows to remaining ports in the same link aggregation group (LAG.) In an embodiment, the MCU unit may assert a control signal to every network device in each redundant set, the network device may read reason code from the MCU and alert control/data plane services of a v-cable operating configuration change or various other conditions. In an embodiment, a network device connected to v-cable may program the MCU to assert a control line to every other network device for an out-of-band communication mechanism.

FIG. 3B, FIG. 3C, and FIG. 3D show an example of v-cables being incorporate into servers, access, aggregate layers, respectively and in successive illustration if the flexibility of the disclosure herein. Like numbers were used to refers to similar devices. Those who are skilled in the art would appreciate that the incorporation of the disclosure herein may not be limited to a particular topology and may be incorporate in other network topologies and/or to connect other network devices. FIG. 3B illustrate an example topology where 1:2 and 2:1 v-cable configuration is applied. Server 300a is connected to downstream of v-cable 310 while a redundant set of T0s 320 is connected to upstream of v-cable 310. The redundant set of T0s 320 connects to downstream of v-cables 330. It should be noted that horizontal redundancy of 2 in FIG. 3B, is used to connect T0s 320 to T1 340. The horizontal redundancy here may be provided utilizing LACP or a similar technology. T1 340a and T 350b are connected as upstream devices to v-cables 330. FIG. 3B illustrated 4 data traffic flows F 1, F 2, F 3, and F 4 where flows F 1 and F 3 maybe referenced as downstream flow(s) and flows F 2 and F 4 may be referenced as upstream flows. In FIG. 2B, connector pairs numbering of downstream redundant set of a v-cable is shown on the top leftmost corner and numbers increment along the y-axis leading to the bottom leftmost corner while upstream redundant set numbering is shown on the bottom rightmost corner and numbers increment along the y-axis leading the right topmost corner. It should be noted than blackholes BH numbers are annotated. In FIG. 3B, black arrows show network data flow direction from either downstream redundant set to upstream redundant set and vice versa, while secondary/standby flows are set to blackhole element shown inside a v-cable.

FIG. 3B shows an example network which may implement the disclosure herein where downstream network data flow F 1 is hashed (or sent via a configurable function,) to port C 342a RX (or RX 342a for simplicity.) Network data packet belonging to flow F 1 may travel via each hop as follows:
a. T1 340a will hash F 1 packet to port TX 341a using a configurable hash function,
b. Subsequently, F 1 packets may arrive at port RX 335a of v-cable 330a with 2:1 redundancy configuration. It should be noted that the upstream redundancy set has only one network device which result in port C 335a being primary/active all the time,
c. The switch element in v-cable 330a may broadcast F 1 packets to every port of the peer redundancy set, leading to F 1 packets arriving at ports TX 333a and TX 334a at approximately the same time,
d. Both T0s 320 network device may the same data packets of flow F 1 arriving at ports RX 323, T0s 320 may hash flow packets to the same ports TX 321 by virtue of a configurable hashing function for the redundant network device,
e. F 1 data packet may arrive at v-cable 310 ports RX 315 and RX 314 of the upstream redundant set. The switching module of v-cable 310 may sent all packets arriving at a secondary/standby port RX 315 to a blackhole module BH 312 and all packets arriving at a primary/active port RX 314 to every port of the downstream redundant set (or network devices.) It should be noted that the aforementioned behavior filters out duplicate packets effectively and in real time,
f. It should be noted that v-cable 310 may select port RX 315 to become active while processing packet of F 1, which should result in no packet loss (or minimal packet loss) due to the fact that F 1 packet are flowing on both RX 315 and RX 314 at the same time regardless of their primary/secondary status.
g. F 1 data packets arriving at port TX 313 of v-cable will be transmitted to downstream compute device Server 300
h. Server 300 may receive F 1 data packets via RX 301a.
i. It should be noted that downstream flow F 3 arriving at RX 352a may follow a path similar to F 1 data packets, namely F 3 packets may arrive at port TX 351a of T1 350a, subsequently at port RX 335a of v-cable 330b, followed by ports RX 322 of T0s 320, followed by primary/active ports RX 314 and secondary/standby port 315 of v-cable 310, followed by F 3 packets arriving at port RX 314 may be broadcast to port TX 313 of v-cable 310, followed by F 3 packets arriving at RX 301a of Server 300a.

Similar to downstream network flows F 1 and F 3, upstream network flows F 2 and F 4 show in FIG. 3B may traverse the example network implementing the disclosure herein, as follows:
a. Server 300a is a single network device (or compute device) in v-cable 310 redundant set, may send packets of flow F 2 to port TX 301a, which is connected to v-cable 310,
b. Flow F 2 packets may be received by port RX 313 of v-cable 310, where flow packet may be broadcast to all upstream network devices, namely ports TX 314, and TX315,
c. Flow F 2 packet may be a received by ports TX 314, and TX 315 and transmitted to ports RX 321 of T0s 320,
d. Both T0s may use a configurable hash function and may send flow F 2 traffic to ports TX 323 for transmission to upstream network devices,
e. Flow F 2 packets may be received by ports RX 333a and RX 334a of v-cable 330a. It should be noted while flow F 2 packets may be duplicate at T0s device, they get sent (or hashed) to the same v-cable implementing the disclosure herein, which may filter duplicate packets by the virtue of allowing the primary/active port to broad cast to all peer redundant set,
f. Flows F 2 packets arriving at secondary/standby port RX 334a may be sent to BH 331a and may travel no further, while packet arriving at primary/active port RX 33a may be broadcast to the only TX port in the peer redundant set; port TX 335a,
g. It should be noted that v-cable 330 may switch one of its standby devices to become an active device, there may be no traffic loss experienced by flow F 2 as packets are arriving at the same time at both RX 333a and RX 334a by virtue of configurable hash functions of T0s,
h. Flow F 2 packet may arrive at port RX 341a of T1 340a which hashes the flow F 2 traffic to port TX 342a.
i. It should be noted that upstream flow F 4 arriving at TX 301a may follow a path similar to F 2 data packets, namely F 2 packets may arrive at port RX 313 of v-cable 310, subsequently at ports TX 314 and TX 315 of v-cable 310, followed by ports RX 321 of T0s 320, followed by ports TX 322 of T0s 320 by virtue of configurable hash function, followed by ports RX 333b and RX 334b of v-cable 340b, followed by BH 331 for packets emanating from RX 333b and port TX 335b for packets emanating from RX 334b of v-cable 330b, followed by port RX 351a of T1 350a and subsequently to the upstream network.

While FIG. 3B illustrates redundancy utilizing spine-leaf topology, those skilled in the art would appreciate that the disclosure herein may be incorporate between any two or more network devices of any network topology. In some embodiments, the v-switch module(s) may utilize plug and play concepts and may implement the capability of increasing the redundant set size or adding extra redundant network devices, while the network may be operational with no disruptions to customer traffic.

Similar to the example network segment of FIG. 3B, FIG. 3C increases the redundancy number of T1 device to 3 and the example network may utilize v-cable with configurations 1:2, 2:3, and 3:1. Those skilled in the art may notice that 1:2 redundancy is a mathematical way of static that network flow is duplicated, 2:3 indicates that the network flow is not tripled, while 3:1 indicates that the network flow is now reduces to a single flow with no duplicates. In FIG. 3C, v-cable 330a will broadcast ingress downstream traffic on the primary/active port RX 333a to T1s 340 and may be received by ports RX 341. Also, v-cable 360 will receive three duplicate network packets of flow F 2 by the virtue of configurable hashing function of T1s 340. Only packets received via RX 365 od v-cable 360 will be broadcast to a network device of 1 which is T2 380 and further upstream into the network. It should ne noted that the same may be applied to downstream traffic where for example flow F 3 arriving at port RX 376 of v-cable 370 may be broadcast to ports TX 373, TX 374, and port TX 375 and further to ports RX 252 of T1s 350 and will be received by ports RX 335, RX 336, and RX 337. Packets active port RX 336 may travel further downstream by broadcast feature of v-cable 330b while packet arriving at ports RX 335 and RX 334 may be sent to blackhole BH 332b. It should be noted that remining data flows is similar to the flow described in FIG. 3B above.

Similar to FIG. 3B and FIG. 3C, FIG. 3D adds an extra level of redundancy to the same example network segment at the server layer and the example network may utilize v-cable configuration of 2:2, 2:3, and 3:1 redundancy topologies. It should be appreciated to those skilled in the art to have the ability of redundant application for real time and/or mission critical applications.

Real time network data of servers 300 may be received by ports TX 301 and received further upstream by ports RX 313 and RX 314, where data received by primary port RX 313 may traverse the network further while data received by secondary port RX 314 may be by blocked by BH 311. It should be noted that downstream traffic may be received by servers 300 at the same time.

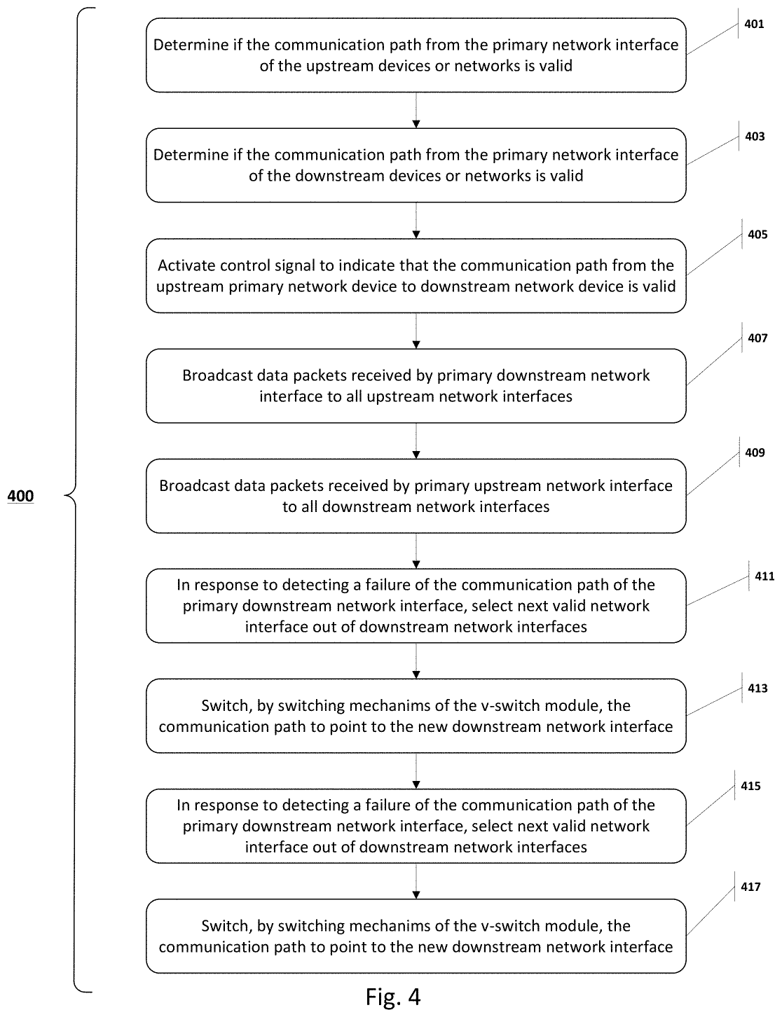

FIG. 4 illustrate an example operational procedure for establish data communication path in accordance with the present disclosure. It should be noted that the order of execution of the operations presented is in no particular order and that an alternative order(s) is(are) possible and is(are) contemplated. The choice of the order, the operations have been presented with, is for the ease of description and illustrations. It should be appreciated that operations may be added, omitted, and/or performed concurrently, without departing from the scope of the appended claims and the disclosure herein.

It should also be noted that the illustrated methods may be broken into smaller sub-methods or sub-tasks and that the execution of the illustrated methods my not entail the execution of every sub-method (or sub-task.) Some or all of sub-tasks of the methods, and/or considerably equivalent sub-tasks, can be carried out by the execution of computer program (set of computer-readable instructions) provided via on a computer-readable storage media. A computer program and variants thereof, as used in description and claims, is widely used herein to include applications, application libraries and modules, routines, program modules, data structures, algorithms, components, microcode, and the like. Computer programs can be carried out by various form of computing devices and configurations such as single-processor or multiprocessor systems, portable computers (laptops,) personal computers, handheld device (smartphones, tablets, and etc.,) microprocessor-based devices, mainframes, minicomputers, cloud-based computers, field programmable gate array (FPGA,) programmable consumer electronics and/or combinations of, thereof and the likes. Furthermore, some or all of the sub-tasks of the illustrated methods may be hardwired (or hardcoded) into a special purpose circuitry (or computer) for further gain in performance and efficiency.

It should be noted that the logical methods described herein may be implemented in; 1) computer program or modules running on a computer system and/or 2) a digital logic circuitry or combinations of digital circuit modules within the computer system. The choice of computer programs and/or digital circuits may be depending on the system requirements, performance and overall cost. Thus, logical operations of the illustrated methods may be referred to states, acts, structural devices, or modules herein. Those logical operations may be implemented using software, firmware, special purpose circuitry (or computer,) and/or any combinations of, thereof.

For example, the methods of routine 400 are described herein as being carried out partially on in their entirety, by modules running the feature disclosed herein and can be dynamically linked library (DLL,) a statically linked library, functionality carried out local or remotely, via calls to an application programming interface(s) (API,) functionality carried out by calls an application binary interface(s) (ABI,) a compiled program, a script, an interpreted program and/or the likes. Data can be stored in computer system memory either; 1) locally and be retrieved via computer system random memory (RAM) address lines, or 2) remotely and can be retrieved via API calls to a remote system.

It should be appreciated to methods of routine 400 may be, in part or all, carried out by a local processor, remote processor, or a special purpose circuitry. Also, some or all of the sub-task of the methods illustrated in routine 400 may be additionally or alternatively be carried out by a dedicated standalone chipset or by a chipset working in conjunction with other software modules. In the illustration below, one or modules of a computer system cand receive and/or process the data disclosed herein. Any service, special purpose computer, or application suitable for carrying out the techniques disclosed herein can be used in operations described herein.

The operational procedure may be implemented in a network comprising a plurality of a set of at least two upstream network devices (referred to as redundant upstream devices, or upstream devices for simplicity,) and plurality of a set of at least two downstream network devices (referred to as redundant downstream devices, or downstream devices for simplicity.) The downstream devices or networks may be communicatively coupled to network interfaces of upstream devices or networks using plurality of data cables. The data cables may comprise an embedded (or alternatively, a standalone v-switch device per disclosure herein) switching module configured to switch communication paths between the downstream devices and upstream devices. The data cables may communicatively couple one of the plurality of redundant upstream devices or networks to one of the plurality of redundant downstream devices or networks such that each of the downstream devices or networks has a communication path to one of the upstream device and multiple switchable communication paths and vice versa. In some embodiment, the network devices either upstream or downstream, do not arbitrate primary/secondary status via direct communication. Referring to FIG. 4, operation 401 and 403 determine the communication path validity between primary downstream device or network and upstream device or network. It should be appreciated that operations 401 and 403 may be independent and may be carried out concurrently. In some embodiments, the communication path may correspond to the first ports of the upstream redundant set connecting to the first ports of the downstream redundant set.

Operations 401 and 403 may be followed by operation 405. Operation 405 illustrates activating a control signal to indicate the communication path between the primary downstream network (or device) to the primary upstream network (or device) is determined to be valid.

Operation 405 may be followed by operations 407 and 409. Operation 407 illustrates duplicating the data signals (or network traffic) of primary downstream device to all upstream devices while operation 409 illustrates duplicating the data signals (or network traffic) of primary upstream network device too all downstream devices. It should be appreciated that operations 407 and 409 may be carried out concurrently.

Operation 409 may be followed by operation 411. Operation 411 illustrates that in response to an invalid signal for the primary downstream interface, modifying the control signal to select the next valid downstream interface out of the set redundant downstream devices. The operation may call the next valid downstream interface, a primary downstream interface.

Operation 411 may be followed by operation 413. Operation 413 illustrates that I response to modifying the control signal, the switching device (v-switch) modifies the communication path to connect the next valid primary downstream device or network to the primary upstream device or network.

Operation 413 may be followed by operation 415. Operation 415 illustrates that in response to an invalid signal for the primary upstream interface, modifying the control signal to select the next valid upstream interface out of the set redundant downstream devices. The operation may call the next valid upstream interface, a primary upstream interface.

Operation 415 may be followed by operation 417. Operation 417 illustrates that I response to modifying the control signal, the switching device (v-switch) modifies the communication path to connect the next valid primary upstream device or network to the primary downstream device or network.

In an embodiment, the data cable is a DAC cable. In an embodiment, the data cable is QSFP28. In an embodiment, the embedded MCUs of v-cables may comprise a separate network device with simple function of duplicating network traffic and may be places on either ends of the communication path. In an embodiment, the control signal may be a control plane signal implemented using conductor of the DAC cable. In some embodiments, the control is one of 2 level signal or serial bus. In an embodiment, the control signal may be carried is on an I2C bus of the data cable or serial bus.

In an embodiment, detecting a failure may be conducted by one or any of the downstream devices or networks. In an embodiment, detecting a failure may be conducted by one or any of the upstream devices or networks. In an embodiment, detecting a failure may be detected by the switching element embedded into the cable or by the standalone switching device. In an embodiment, switching data path may be signaled to all upstream and downstream devices. In an embodiment, any of the connected devices or networks may trigger a communication path change.

In an embodiment, the failure is detecting when a network element fails to either generate heartbeat signal or respond to heartbeat signal for configurable duration of time.

In an embodiment, the set of redundant upstream devices may all use the same flow hashing function, may all receive the same downstream network traffic on the same corresponding network interface and may all transmit the network traffic of the same network flow via the same network interface further upstream the network. A network flow may be defined by layer-3 5 tuples (source address, destination address, source port, destination port, and protocol identifier.) Similarly, in an embodiment, the set of redundant downstream devices may all use the same flow hashing function, may all receive the same upstream network traffic on the same corresponding network interface and may all transmit the network traffic of the same network flow via the same network interface further downstream the network.

Those who are skilled in the art would appreciate the resiliency and instantons switch of network communication path of the disclosure herein. The serving primary network interface and every secondary network interface each may have the same network data flow through regardless of its redundancy status and so switching one of the secondary interfaces to become a new primary network interface may incur minimal packet loss due to the communication path switching action.

In an embodiment, there might be a case where no secondary interface of say upstream device, is ready to become active, the v-switch unit may indicate to all downstream devices or network a lost of the network interface. The latter may enable horizontal schemes to kick in and may eliminate the network interface from the horizontal redundancy group. Vice versa may also be applicable to downstream network interfaces.

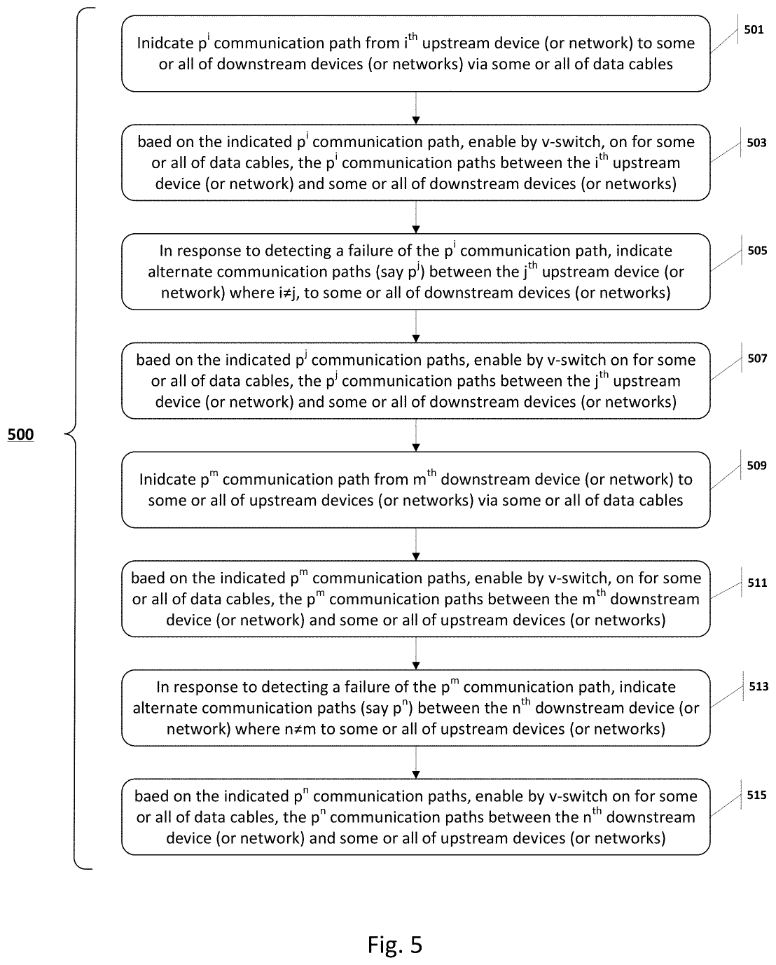

FIG. 5 illustrates resilient and instantaneous failover mechanism in accordance with the disclosure herein. The operational procedure may be implemented in a system comprising of plurality of sets of at least two or more downstream devices (or networks,) that are communicatively coupled using plurality of data cables to plurality of sets of at least two or more upstream servers. The data cables may each implement v-cable which may comprise a switch device as per disclosure herein. In an embodiment, the data cable may include two or more on ether end of the cable. Some embodiments may implement plurality of switching devices, v-switch as a separate device. The switching device may be configured to switch communication paths between upstream devices and downstream devices. Each data cable may communicatively couple a set of downstream networks (or devices) to a set of upstream networks (or devices.) In FIG. 5, operation 501 indicates a primary communication path pⁱ between the i^{th} upstream device (or network) and some or all of downstream devices (or networks.)

Operation 501 may be followed by operation 503. Given the indication of communication path pⁱ, Operation 503 illustrates that communication path pⁱ may be enabled between the i^{th} upstream device (or network) and some or all of the downstream devices (or networks,) by the switch module of some or all data cables (or by a standalone v-switch device.)

Operation 503 may be followed by operation 505. Operation 505 illustrates that when a failure of the communication path pⁱ, due to a failure of the i^{th} upstream device, is detected by the switch modules, alternate communication path(s) p^{j} is/are indicated between the i^{th} upstream device (or network) and some or all of the downstream device or networks, where i≠j should be appreciated that failure of the i^{th} upstream device may result in distributing the pⁱ communication path to multiple communication paths p^{j} based on the selection criterion of the switch module of the data cable (or of the v-switch device.) In some embodiment, the upstream device with best link quality may be selected next to serve as primary provider of network traffic to a downstream device (or network.) Other embodiments may follow round-robin (or any other selection criterion) to select the next primary interface based on a priority order resulting on j^{th} upstream device replacing i^{th} upstream device when a failure is detected. Some embodiments may utilize random selection criterion to select the next primary interface. Those skilled in the art would appreciate the tradeoffs different selection criteria, efficiency complexity, and cost of the implemented system.

Operation 505 may be followed by operation 507. Given the indication of communication path p^{j}, Operation 507 illustrates that communication path(s) p^{j} may be enabled between the j^{th} upstream device (or network) and some or all of the downstream devices (or networks,) where i≠j, by the switch module of some or all data cables (or by a standalone v-switch device.)

Operations 509, 511, 513, and 515 may follow operation 507 and are similar to operations 501, 503, 505, and 707 respectively. Operations 509, 511, 513, and 515 show operational procedure of resilient and instantaneous failover mechanism in accordance with the disclosure herein, where the m^{th} downstream device failure is detected. Operation 509 may indicate a communication path p^{m} between the m^{th} downstream device (or network) and some or all of the upstream devices (or networks.) Operation 511 may switch the p^{m} communication path using embedded switch module of some or all data cables (or standalone v-switch device,) on between the m^{th} downstream device (or network) and some or of the upstream devices (or networks.) Operation 513 may instantaneously indicate a new communication path pⁿ between the n^{th} downstream device (or network) and some or all of the upstream devices (or networks) using some or all of the data cables (or a standalone v-switch device,) when a failure of communication path p^{m} is detected, where m≠n. Given the indication of communication path p^{m}, Operation 515 illustrates that communication path(s) p^{m} may be enabled between the m^{th} downstream device (or network) and some or all of the upstream devices (or networks,) where m≠n, by the switch module of some or all data cables (or by a standalone v-switch device.)

FIG. 5 illustrates resilient and instantaneous failover mechanism in accordance with the disclosure herein. The operational procedure may be implemented in a system comprising of plurality of sets of at least two or more downstream devices (or networks,) that are communicatively coupled using plurality of data cables to plurality of sets of at least two or more upstream servers. The data cables may each implement v-cable which may comprise a switch device as per disclosure herein. In an embodiment, the data cable may include two or more on ether end of the cable. Some embodiments may implement plurality of switching devices, v-switch as a separate device. The switching device may be configured to switch communication paths between upstream devices and downstream devices. Each data cable may communicatively couple a set of downstream networks (or devices) to a set of upstream networks (or devices.) Operation 601 indicates that network data is being transmitted and received among the networks (or devices) of the x^{th} redundant sets, that are communicatively coupled via port (or interface) x using data cable (or v-switch devices) implementing the disclosure herein. Port (or interface) x^{m} is the primary/active port of the m^{th} upstream device (or network,) while port (or interface) xⁱ is the primary/active port of the i^{th} downstream device (or network.)

Operation 601 may be followed by operation 603. Operation 603 illustrates receiving control signal to indicate that port (or interface) x^{k} of the k^{th} downstream device (or network) may be selected to become primary/active. The switch module embedded within the cable (or standalone switch modules,) of the x^{th} redundant set may switch the communication path on between and k^{th} downstream device (or network) and all of the upstream devices (or networks.)

Operation 605 may follow operation 603. Operation 605 indicates that network data is being transmitted and received among the networks (or devices) of the y^{th} redundant sets, that are communicatively coupled via port (or interface) y using data cable (or v-switch devices) implementing the disclosure herein. Port (or interface) yⁿ is the primary/active port of the n^{th} upstream device (or network,) while port (or interface) y^{j} is the primary/active port of the j^{th} downstream device (or network.)

Operation 605 may be followed by operation 607. Operation 607 illustrates receiving control signal to indicate that port (or interface) y^{o} of the o^{th} upstream device (or network) may be selected to become primary/active. The switch module embedded within the cable (or standalone switch modules,) of the y^{th} redundant set may switch the communication path on between and o^{th} upstream device (or network) and all of the downstream devices (or networks.)

In an embodiment, the data cable is a DAC cable. In an embodiment, the data cable is QSFP28. In an embodiment, the embedded MCUs of v-cables may comprise a separate network device with simple function of duplicating network traffic and may be places on either ends of the communication path. In an embodiment, the control signal may be a control plane signal implemented using conductor of the DAC cable. In some embodiments, the control is one of 2 level signal or serial bus. In an embodiment, the control signal may be carried is on an I2C bus of the data cable or serial bus.

In an embodiment, the v-switch device may select network (or device) to be primary/active based on best available link quality. In an embodiment, the v-switch device may select network (or device) to become primary/active based on configured priority order.

It should be noted that examples and embodiments herein are used to explain and illustrate certain aspects of the disclosure herein, and should not limit the disclosure. Those who are experienced in the art may appreciate that logical methods, operations and various aspects of the disclosure herein may be implemented as computer processes, a computer-controlled apparatus, a computing system, an article of manufacture such as blueprints, or a special purpose circuitry, or programmable hardware such as field-programable gate array (FPGA) device, a graphics processing unit (GPU,) an application-specific integrated circuit (ASIC,) a system on chip (SoC,) microcode-base control unit, a distributed application, a massively parallel processing (MPP) device, or etc. A component may comprise subcomponents that are implemented on one or more of the aforementioned systems. It should be noted that component decomposition and type of system platform implementing those components, are subject to design target efficiency, performance, and/or cost. The choice of system platform should not limit the scope of the claims present herein.

It should also be noted that components implementing the disclosure herein may be implemented on system configurations beyond those described herein, including cluster/grid computing. The embodiments illustrated herein may be implemented on a distributed environment where compute resources and/or storage resources may be located in different clusters/grids and are communicatively coupled via networks similar to networks comprising data center similar to data center 100 illustrated in FIG. 1.

Networks may be designed to host and/or cohost variety of physical/virtualized compute services, storage services, virtualized and/or hybrid networks infrastructure, and may comprise one or more data centers similar to data center 100 illustrated in FIG. 1. Clients of those networks may overlay virtual networks on top of existing physical networks infrastructure, may distribute compute and storage resource across multiple data centers, and may provide services to other clients and/or end-users via public networks such as the Internet.

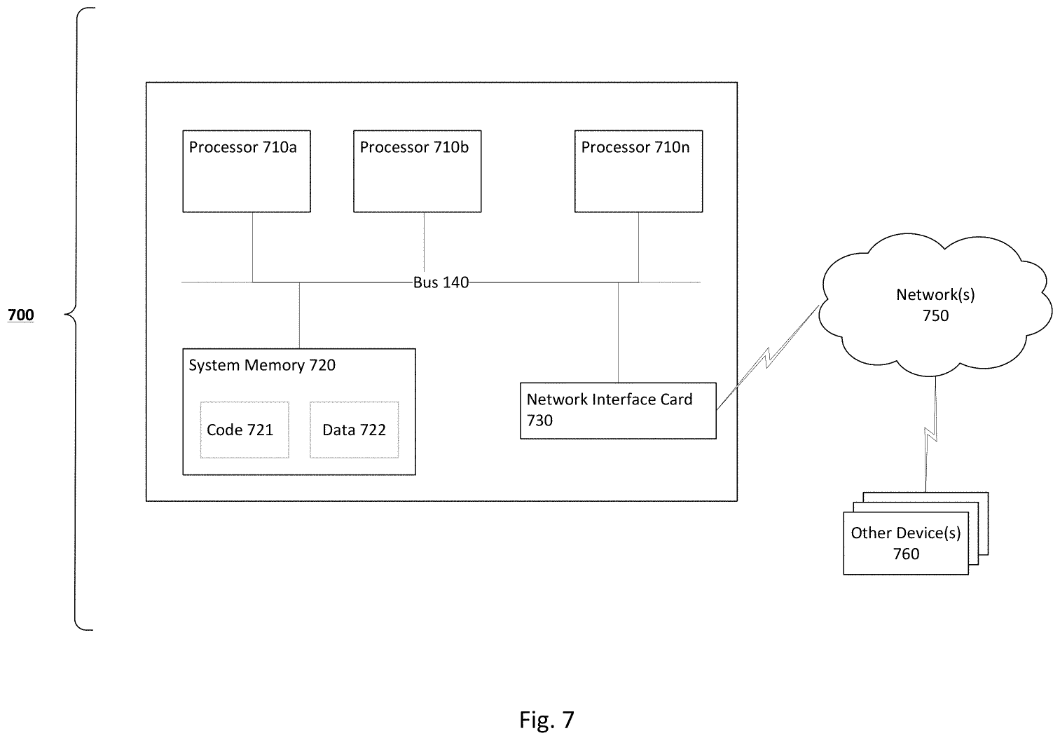

In an embodiment, the physical compute resource of data centers such data center 100 depicted in FIG. 1, may be called droplet, may be multiple of rack units (U or RU,) and may be rack mounted. One or more physical compute resource may implement one or more of the technologies described herein. A physical computer resource may include a general-purpose computer system that is configured to access one or more computer peripherals. FIG. 7 illustrate a generic architecture of a general-purpose computer system, computing node 700. Computing node 700 includes one or more general-purpose processors 710a, 710b, . . . , and 710n (which may be referred to herein singularly as “processor 710” or in the plural as “processors 710”,) system memory 720, network interface card (NIC) 730, and an input/output (I/O) bus 740.

In several embodiments, processors 710 may comprise multiple processor chips, multiple cores on a single chip, or combination of thereof. Other embodiments, computing node 700 may contain a uniprocessor 710. Processors 710 may be implementing various instruction sets computing architectures such reduced instruction set computing (RISC) such as advanced RISC (ARM)-based processors, replaceable processor architecture (SPARC,) multiprocessor without interlocked pipeline stages (MIPS) architecture, PowerPC architecture, cell broadband engine architecture (CBEA,) or complex instruction set computing (CISC) architecture such as x86 based architecture, amd64 based architecture or etc. It is often times that multiprocessor may implement the same instruction set. Multicore processor chips may have cores of different computing horsepower such as big.LITTLE arm based architecture.

FIG. 7 shows computing node 700 may have system memory 720. System memory 720 may store various contents such as executable code (shown as code 721,) program stack space (not shown in FIG. 7,) and heap memory (shown as 722) in different memory segments with different access privileges. In an embodiment, some memory segments may be shared among different applications running concurrently in the computing node 700. System memory 720 may be static random-access memory (SRAM,) dynamic RAM (DRAM) such as double data rate (DDR) DRAM, nonvolatile RAM (NVRAM,) flash RAM, etc. system memory 720 may implement error correction code (ECC) RAM.

In some embodiments, I/O bus 740 may transport data and content between different peripherals sharing the bus. For example, processor 710 may read or write to memory segments via access to the I/O bus 740. In some embodiment, processor 710 may retain cache copy of partial memory segments for faster execution of application code. Also, network traffic arriving via NIC 730 peripheral may be transported via I/O bus 740 to system memory 720. In some embodiments, I/O bus 740 may implement standard bus technologies such as peripheral component interconnect express (PCIe,) universal serial bus (USB,) small computer system interface (SCSI,) I2c, or combination of thereof. Some embodiments may direct memory access (DMA) between processor 710 and system memory 720.

In FIG. 7, computing node 700 may access other computing nodes similar to those shown in data center 100 in FIG. 1, via network interface card (NIC) 730. The NIC 730 may be connected to a wired network implementing Ethernet interface, asynchronous transfer mode (ATM) interface, integrated services digital network (ISDN,) etc. In some embodiments, The NIC 730 may be wirelessly communicating with other networks using various of IEEE 802.11 standards, third partnership project (3GPP,) etc.

Some embodiments may include peripheral to read permanent memory medium such as magnetic disks, optical disks, etc. Various permanent memory devices may include non-volatile memory module(s) such as ROM, EEPROM, and/or volatile memory module(s) such as RAM, SRAM, DDR RAM, etc. In an embodiment, computer instructions implementing embodiments and methods disclosed herein may be transported using over the wire using NIC 730 and may be stored on a computer readable permanent memory medium. In an embodiment, the permanent memory medium may be provided part of storage service and may not be collocated with compute node. Some embodiments may utilize efficient memory access protocol such as remote direct memory access (RDMA) to access remote memory contents. Embodiments, methods, and functionality disclosed herein may be implemented of computer system similar to computing node 700 shown in FIG. 7. Other implementation may utilize custom systems such as a special-purpose computing device, computer storage, and/or network device in addition to the general-purpose system shown in FIG. 7. A computing device may be a combination of general-purpose system, custom system and/or other computing system not mentioned here, and may be used to implemented the disclosure herein.

It should be noted that a computer storage and their associated computer-readable medium may be implemented using a number of technologies such as blue ray disc (BD,) digital versatile disc (DVD,) and/or compact disc read-only memory (CD-ROM,) hard disk, solid-state disks (SSD,) NAND flash drives, etc. it should be appreciated that other technologies of storage device not mentioned here may provide computer storage accessible by a computing device.

Computer storage devices may include solid-state based media such as RAM, SRAM, DRAM, SDRAM, DDR DRAM, ROM, EEPORM, etc., may include magnetic based media such as hard drives, magnetic tapes, magnetic cassettes, and may include optical based media such as CD-ROM, DVD, BD, etc., or may include any other medium capable of storing computer program module, data structure, or other data. For purpose of the claims, the term “computer storage medium,” or “computer readable media” or variations of thereof may not include signals transitory medium such communication medium where signals are transmitted over the wire, the air, and/or optical guided medium.

Computer readable data may be encoded into various forms in order to match the storage medium characteristic of retentions. For example, a computer data may be encoded into magnetic waves for storage onto magnetic based medium, may be encoded into electrical signals for storage onto solid sated based medium, may be encoded into optical forms for storage onto optical based medium or etc. The software implementing the disclosure herein may be encoded in various format to match the storage medium.

As discussed above, those skilled in the art may appreciate that various transformation type may take place in the disclosed computing devices when storing and executing software modules/component and or functionality disclosed herein. The disclosed computing devices may include other components not shown in FIG. 7, may include some or all of components shown in FIG. 7, and/or may utilize different computing architecture and/or platform.

It should be noted that various embodiments presented herein to show various forms of implementing the claimed subject matter and the use of languages related to structural feature or methodological acts should not limit the subject matter herein to those languages.

Unless understood from the context or stated otherwise, conditional language used herein is to indicate that some embodiments may, while other embodiments may not, include certain aspects, features, elements, and/or steps. Among conditional languages used are “may,” “might,” “can,” “could,” and the likes. Thus, such a conditional language use is generally intended to imply that one or more embodiments are not, by any means, required to include all of the aspects, feature, elements, and/or steps nor that those embodiments include logic for deciding, with or without author input or prompting, whether to include certain aspects, features, elements, and/or steps, or to perform certain aspects, feature, elements, and/or steps in any given order. The terms “comprising,” “including,” “having,” and etc. are synonyms and are used in an open-ended fashion in a way not preclude additional acts, features, elements and so on. Also, the term “or” is used in its inclusive way, rather of its exclusive sense, to mean one, some or all of. For example, when used with traverse a set of cities, the term “or” means one, some or all cities.

Embodiments described herein are examples of various implementations and should not limit the scope of the inventions disclosed herein. Thus, the aforementioned description should not imply that any particular aspect, feature, element, module, steps, is a must or indispensable. Indeed, embodiments may implement the novel methods and systems described herein in a variety of other forms, furthermore various omissions, substitutions, replacements, and/or changes may be made to other forms of implementation without departing for the spirit and scope of the inventions disclosed herein.

It should be appreciated that any reference to numbered items with the description and summary is not intended to reference corresponding items of claims sections.

1. A method for parallelizing network devices of a network comprising a set of at least two redundant network devices, a plurality of downstream devices (or networks,) a plurality of upstream devices (or networks,) and a set of two switching devices comprising a plurality of switching modules, the downstream devices (or networks) communicatively coupled to network interfaces of the set of redundant network devices using a plurality of switching modules, the upstream devices (or networks) communicatively coupled to network interfaces of the set of redundant network devices using a plurality of switching modules, each switching module configured to switch the communication paths between the set of redundant network devices and one of the downstream devices (or networks) or to switch the communication paths between the set of redundant network devices and one of the upstream devices (or networks) so that each of the downstream devices (or networks) or each of upstream devices (or networks) has a switchable communication paths to each network device of the set of redundant network devices, the method comprising:
each device of the set of redundant network devices having a one-to-one mapping of their network interfaces (or corresponding network interface;)
corresponding network interface of the set of redundant network devices connecting to the same switching module;
each device of the set of redundant network devices routing ingress data packets of the same network flow to egress from the same (or corresponding) network interface;
each set of corresponding network interfaces of the set of redundant network device has one interface designated as primary/active and the remaining interfaces designated as secondary/standby;
switching module broadcasting incoming (or ingress,) data packets to all of the network interfaces of the set of redundant network devices;
switching module blackholing outgoing (or egress,) data packets of all secondary/standby network interfaces of the redundant network devices;
switching module routing outgoing (or egress,) data packets of the primary/active network interface of the redundant network devices;
determining the validity of the communication link between the first network device of the set of redundant network devices and the first downstream (or upstream,) device or network;
raising a control signal to assert a valid communication path when the communication path between the first network device of the set of redundant network devices and the first of the downstream (or upstream,) device or network is determined to be valid;
in response to the asserted control signal, the switching module recognizes the network interface of the first network device of the set of redundant network devices as a primary/active interface;
in response to detecting a failure in the communication path, raise a control signal to assert a valid communication path when the communication path between the second network device of the set of redundant network devices and the first of the downstream (or upstream,) device or network is determined to be valid;
In response to the asserted control signal, the switching module recognizes the network interface of the second network device of the set of redundant network devices as a primary/active interface.

2. The method of claim 1, wherein network data traffic is routed by the v-switch to every device of the set of redundant devices.

3. The method of claim 1, wherein each device of the redundant devices routing network data traffic of the same network flow to the same (or corresponding) port and the network data traffic ingress into the corresponding v-switch device simultaneously.

4. The method of claim 1, wherein the v-switch device filters out duplicate packets of a network flow produced by each device of the redundant devices.

5. The method of claim 1, wherein ports of the v-witch devices are one or combination of SFP, QSFP, OSFP ports.

6. The method of claim 1, wherein control signal is carried over I2C bus of the data cable.

7. The method of claim 1, wherein data cable is direct attach copper (DAC) cable.

8. The method of claim 7, wherein control signal is carried as out-of-band control plane signal over the DAC cable.

9. The method of claim 1, wherein detecting a failure in the communication paths is performed by the switching module of the v-switch.

10. The method of claim 9 and the method of claim 3, wherein switching module of the v-switch device modifies the communication path in case of communication failure, results in instantons switch of the communication path.

11. The method of claim 1, wherein the control signal is modified by a device of the redundant set of devices, by a device of a plurality of downstream devices, by a device of a plurality of upstream devices, or by a control knob of the front panel of the v-switch device.

12. The method of claim 1, wherein switching modules of v-switch provides communication paths among each device of the set of redundant devices for control state information exchange.

13. A system comprising:
a set of at least two redundant network devices;
a set of two switching devices each comprising a plurality of switching modules;
a plurality of downstream devices or networks;
a plurality of upstream devices or networks; and
the downstream devices (or networks) communicatively coupled to network interfaces of the set of redundant network devices using a plurality of switching modules, the upstream devices (or networks) communicatively coupled to network interfaces of the set of redundant network devices using a plurality of switching modules, each switching module configured to switch the communication paths between the set of redundant network devices and one of the downstream devices (or networks) or to switch the communication paths between the set of redundant network devices and one of the upstream devices (or networks) so that each of the downstream devices (or networks) or each of upstream devices (or networks) has a switchable communication paths to each network device of the set of redundant network devices;
the system is configured to:
assert control signals indicating that the first communication paths between the first device of the set of redundant devices to a plurality of downstream device (or networks) and to a plurality of upstream devices (or networks) to be valid;
based on the asserted control signals, the switching modules of the switching device between the set of redundant devices and the downstream device (or networks,) each recognizing the network interfaces of the first device of the set of redundant devices to be primary/active interfaces;
based on the asserted control signals, the switching modules of the switching device between the set of redundant devices and the upstream device (or networks,) each recognizing the network interfaces of the first device of the set of redundant devices to be primary/active interfaces;
in response to detecting a failure in the first communication paths, assert control signals indicating that the second communication paths between the second device of the set of redundant devices to a plurality of downstream device (or networks) and to a plurality of upstream devices (or networks) to be valid;
based on the asserted control signals, the switching modules of the switching device between the set of redundant devices and the downstream device (or networks,) each recognizing the network interfaces of the second device of the set of redundant devices to be primary/active interfaces; and
based on the asserted control signals, the switching modules of the switching device between the set of redundant devices and the upstream device (or networks,) each recognizing the network interfaces of the second device of the set of redundant devices to be primary/active interfaces.

14. The system of claim 13, wherein control signals are implemented using I2C bus connected to the v-switch communication (or network) ports.

15. The system of claim 13, wherein the communication path is determined by the switching module of the v-switch, by a device of the set of redundant devices or by an external control knob on the front panel of the v-switch device.

16. A switching device for coupling a set of at least two redundant network devices and a plurality of devices (or networks,) the switching device comprising of;
a plurality of switching modules each with two set of network interfaces, the first set of network interfaces is facing and used to connect to the set of redundant network devices, and the second set consisting of a network interface is facing and used to connect to one of a plurality of devices (or networks;) and
a switching module programmed to recognize based on an asserted control signal indicative of a valid communication path, one of network interface of the set of redundant device interfaces as a primary/active interface of the redundant set and the remaining interfaces of the set of the redundant network devices as secondary/standby interfaces
wherein the set of redundant set of devices end, the switch module has the first network interface connected to the first interface of the first redundant device and the second switching module network interface connection to the first interface of the second redundant device.

17. The switching device of claim 16, wherein the communication (or network) ports are one or combination of SFP, QSFP, and/or OSFP.

18. The switching device of claim 16, wherein control signals are exchanged between devices of the set of redundant devices and the switch module of the switch device using I2C or serial bus.
